(19) United States
(12) Patent Application Publication
(10) Pub. No.: US 2012/0291886 A1
(43) Pub. Date: Nov. 22, 2012

(54) WATER VOLUME AND PRESSURE CONTROL SYSTEM

(76) Inventor: Federico Rivera, Manati, PR (US)

(21) Appl. No.: 13/109,224

(22) Filed: May 17, 2011

(51) Int. Cl. F16K 31/02

(52) U.S. Cl. 137/487.5

(57) ABSTRACT

A system for remotely controlling the supply and pressure of water to a building includes one or more sensors for detecting the presence of water in undesirable locations, a water flow and pressure regulation unit connected to the building water input supply, and a system controller capable of providing wireless communication with a user via a plurality of external devices.

### BACKGROUND

### Field of the Invention

The present invention relates generally to water control systems, and more particularly to a system for remotely controlling the supply and pressure of water to a building.

Each year, buildings and residences across the globe suffer from water damage caused by leaky appliances, broken pipes and other occurrences wherein the building owner is not aware that damage is occurring until it is too late. Water damage and the resulting mold/health hazards are extremely costly to remediate and often do permanent damage to the value of the building.

With the current emphasis on green technology, many modern appliances are capable of operating on water pressure that is substantially less than the 150-200 psi that is typically supplied by municipal water providers. To this end, when low pressure devices are used for long periods of time on high pressure systems, building owners are not able to fully enjoy the cost and environmental benefits these devices afford. Moreover, in many cases damage to the water saving device can occur from the prolonged exposure to high water pressure.

In each of these instances, the amount of damage caused to the devices and/or the building structure is directly proportional to the time the building owner becomes aware of the issue, and the resulting time necessary to take corrective action.

Automated systems for controlling water flow into a building have been known and include U.S. Pat. No. 6,691,724, U.S. Pat. No. 6,532,979, U.S. Pat. No. 6,491,062, U.S. Pat. No. 6,526,807, and U.S. Pat. No. 7,306,008. The present invention, directed to a remotely operable water control system differs from the foregoing prior art in a number of aspects. The manner by which will become more apparent in the description which follows, particularly when read in conjunction with the accompanying drawings.

### SUMMARY OF THE INVENTION

The present invention is directed to a system for controlling the supply and pressure of water to a building. One embodiment of the present invention can include one or more sensors for detecting the presence of water in undesirable locations, such as underneath appliances, basements and/or equipment rooms. The system can also include a water flow and pressure regulation unit connected to the building water input supply. The regulation unit can be controlled by a system controller capable of providing wireless communication with a user via a plurality of external devices.

Another embodiment of the present invention can include the ability of the system to immediately disable all water entering the building upon the occurrence of a leak situation. Additionally, the system can act to maintain a specific water pressure in the building at all times by regulating the flow of water via the regulation unit.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a simplified schematic drawing of a water volume and pressure control system that is useful for understanding the inventive concepts disclosed herein.

FIG. 2 is a side view of a water regulation unit according to one embodiment of the invention.

FIG. 3 is a schematic block diagram of a system controller according to one embodiment of the invention.

FIG. 4 is perspective view of system controller according to one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

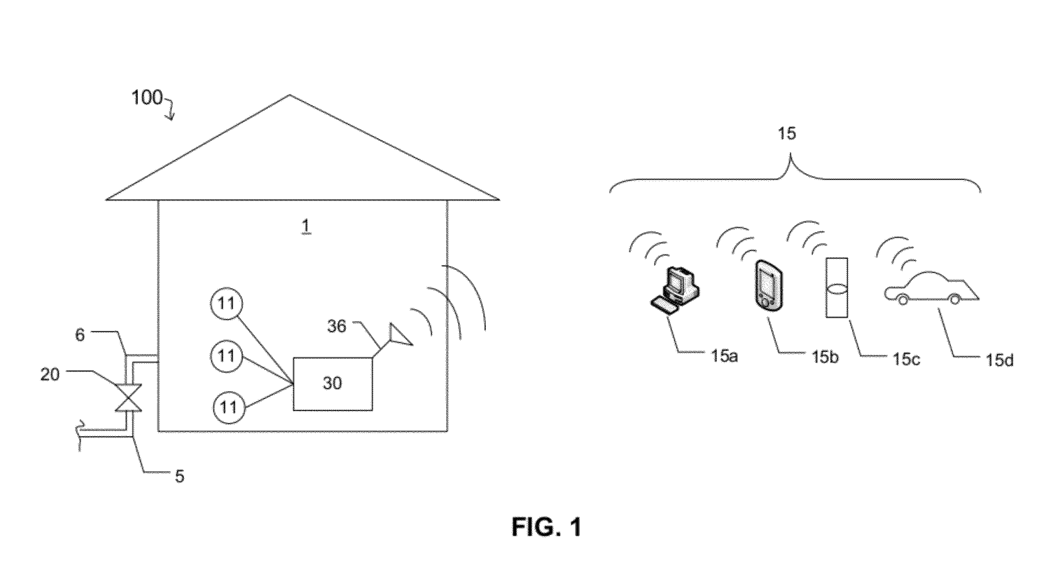

FIG. 1 illustrates one embodiment of a water volume and control system 100 utilized in a building 1, that is useful for understanding the inventive concepts disclosed herein. The system 100 can include a plurality of leak detection sensors 11, a water regulation unit 20 and a control unit 30 which can be remotely accessed by one or more external devices 15.

As described throughout this document, an external device 15 can include any number of known devices capable of providing one or two way communication via known communication protocols such as cellular, Wi-Fi, Bluetooth, Infrared (IR), and other such communication methodologies. Common examples of an external device suitable for use herein can include internet configured computers 15a, cellular telephones (including smart phones with internet access) and Personal Data Assistants 15b, one way IR communicators such as conventional programmable garage door openers 15c and IR communicators integrated into modern vehicles 15d, among many others. As will be described below in detail, one or more external devices 15 can communicate remotely with the control unit 30 in order to remotely operate features of the system 100.

Leak detection sensors 11 can include any number of conventional devices capable of detecting the presence of water and sending an alert signal to a centralized location. Each of these devices can preferably be battery operated and include a wireless communication transmitter capable of communicating with the control unit 30. In one embodiment, the leak detection sensor can comprise a Zircon® 63931 wireless leak sensor, however, virtually any device capable of detecting and reporting the presence of water in a specified location can also be utilized.

In one embodiment, the leak detection sensors 11 can be placed throughout a building/home 1 at locations susceptible to water leaks such as the basement, underneath appliances, or at water pipe junctions, for example. Upon detecting the presence of water, the leak detection sensor 11 can transmit a signal to the control unit 30 indicating that a leak situation has occurred.

Although described above as including wireless transmission, the devices can be connected to the controller via a conventional wire system.

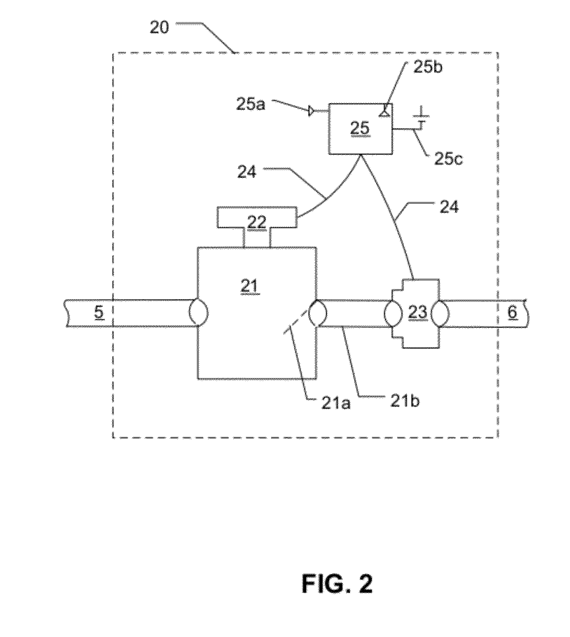

FIG. 2 illustrates one embodiment of a water regulation unit 20, that includes a variable control water flow valve 21, a valve actuator 22, a water pressure sensor 23 and a communicator 25.

As shown, the variable control water flow valve 21 can be installed between the main water supply line 5 and the building plumbing 6, and can preferably include an inner chamber/gate 21a capable of opening and closing the output valve 21b in increments from 0 to 100 percent, thus regulating the volume and pressure of water entering the building plumbing line 6. As described herein, the main water supply line 5 can include any source of fresh water to a building, and the building plumbing can include components within a building configured to receive fresh water and distribute the same throughout the building. In one preferred embodiment, the main water supply and the building plumbing can include the buildings primary water source.

The valve actuator 22 can act to physically manipulate the variable control water flow valve 21, and can include a conventional electric motor and/or solenoid mechanism, for example. These items and their associated functionality are extremely well known in the art, hence no further description will be provided herein.

The pressure sensor 23 can act to provide an instant calculation of the water pressure leaving the valve 21 and residing within the building plumbing line 6. To this end, the pressure sensor can preferably be interposed between the valve 21 and the building plumbing line 6. As will be described below, the pressure reported from the sensor 23 can be relayed to the controller 30 which can then send instructions to the actuator 22 for adjusting the flow valve 21. This circular feedback communication can thus allow the system 100 to maintain a specified water pressure at the building plumbing line 6 at all times.

The communicator 25, according to one embodiment, can act to provide two way communication between the control unit 30 and the water regulation unit 20 via a transmitter 25a and a receiver 25b. To this end, the communicator 25 can be powered from a conventional a/c power source 25c and can be communicatively linked to the valve actuator 22 and the sensor 23 via one or more communication wires 24.

As described herein, both the transmitter 25a and receiver 25b can be substantially the same as the transmitter 36 and receiver 37 of the control unit 30 described below. Moreover, although described above as including wireless communication, one of skill in the art will recognize that conventional communication wires can be used in conjunction with or as an alternative to the transmitter and receiver described above.

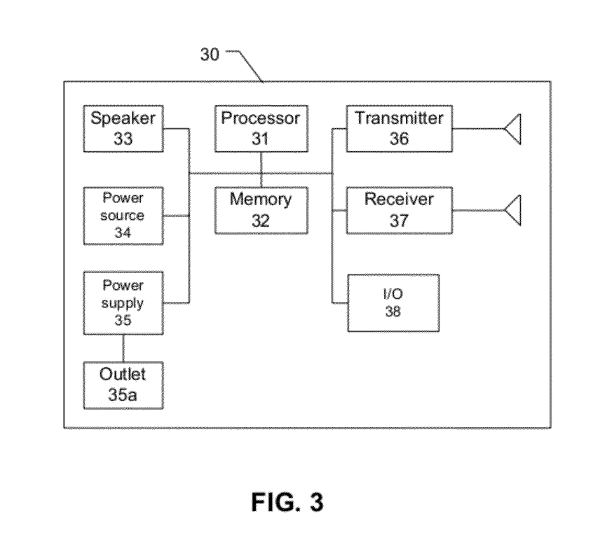

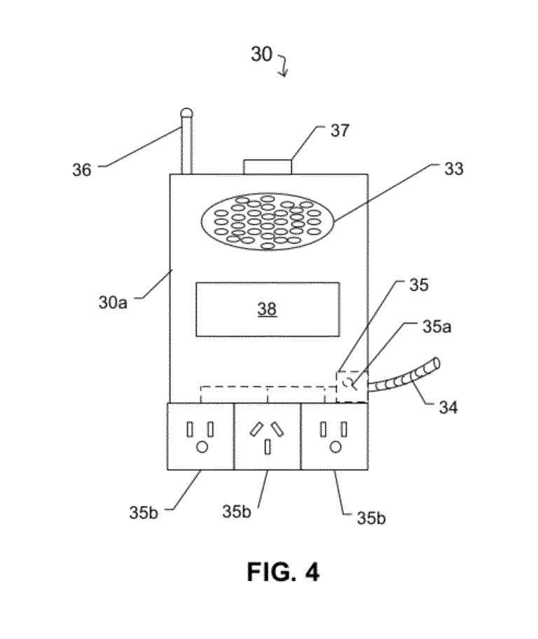

FIGS. 3 and 4 illustrate one embodiment of a control unit 30 configured to command the leak detection sensors 11 and the water regulation unit 20 described above. As shown, the control unit 30 can include a housing 30a having a processor 31 that is conventionally connected to an internal memory 32, a speaker 33, a power source 34, a power supply 35, a transmitter 36, a receiver 37, and an input/output unit 38.

The housing 30a can preferably be constructed from injection molded plastic having a plurality of connectors (not shown) for securely positioning each of the elements 31-38 in a secure and environmentally responsible manner. To this end, the housing 30a can take any number of distinct shapes and can be constructed from any number of known materials.

The processor 31 can act to execute program code stored in the memory 32 in order to allow the device to perform the functionality described herein. Processors are extremely well known in the art, therefore no further description will be provided.

Memory 32 can act to store operating instructions in the form of program code for the processor 31 to execute. Although illustrated in FIG. 3 as a single component, memory 32 can include one or more physical memory devices such as, for example, local memory and/or one or more bulk storage devices. As used herein, local memory can refer to random access memory or other non-persistent memory device(s) generally used during actual execution of program code, whereas a bulk storage device can be implemented as a persistent data storage device. Additionally memory 32 can also include one or more cache memories that provide temporary storage of at least some program code in order to reduce the number of times program code must be retrieved from a bulk storage device during execution. Each of these devices are well known in the art.

The speaker 33 can act to audibly notify a user when one or more of the leak detection sensors reports that a leak situation is occurring. Although described as a speaker, one of skill in the art will recognize that virtually any type of notification device, such as one or more light emitting diodes (LED's), for example, can be substituted for, or used in conjunction with the speaker 33, without deviating from the inventive concepts disclosed herein.

The power source 34 can be connected to the building's A/C electrical system in order to provide power to each component of the control unit 30 in a conventional manner.

The power supply unit 35 can act as a remote switch for controlling the power supplied to one or more water usage devices such as a hot water heater or a water softener, for example. To this end, the power supply unit 35 can include an electrical switch 35a interposed between the power source 34 and one or more outlets 35b, into which the water usage devices can be connected.

In one embodiment, the processor 31 can instruct the power supply unit to terminate one or more of the outlets 35b (thus disabling the operation of a particular water usage device) upon the occurrence of a leak situation, or in response to a command from a user. Such a feature can thus result in a substantial savings in energy costs over the life of the system.

The transmitter 36 can act to transmit operating information in the form of a wired or wireless signal from the controller 30 to an external device 15 and/or the receiver 25b of the water regulation unit 20. In one preferred embodiment, the transmitter can include a variable radio wave transmitter having a unique radio frequency chip capable of transmitting a plurality of independent radio frequencies, which can be pre-programmed into the transmitter or stored in the memory 32.

The receiver 37 can act to receive operating information in the form of a wired or wireless signal from an external device 15 and/or the transmitter 25a of the water regulation unit 20. In one preferred embodiment, the receiver can include a variable radio wave receiver having a unique radio frequency chip capable of receiving and translating a plurality of independent radio frequencies, which can be sent to the processor and/or the memory 32.

Although described as using radio transmission and reception frequencies, other communication mediums and their associated components are also contemplated. For example, infrared (IR), Bluetooth, RFID, microwave, Ethernet, Wi-Fi and other known communication mediums can also be utilized without deviating from the scope and spirit of the inventive concepts disclosed herein.

In an alternate embodiment, the controller 30 can further include a cellular antenna (not illustrated) configured to communicate directly with a secondary device 15 such as a cellular telephone 15b, for example, via a commercial cellular system. To this end, the memory 32 can contain programming for instructing the processor 31 to receive commands transmitted by a cellular telephone 15b. Additionally, the memory 32 can contain programming for instructing the processor to generate a system “voice” for transmitting messages to the speaker of the cellular telephone, or can generate text messages for receipt by the phone (or other device configured to send and receive text messages). Such a feature can allow the system to send and receive information over a cellular network. The methodologies for performing these tasks being well known in the art, no further description will be provided.

The input/output unit 38 can act as a direct means for providing and receiving operating information between a user and the control unit 30. Such a feature can be utilized in instances where wireless communication with an external device 15 is not desired or is unavailable. In one preferred embodiment, the I/O unit 38 can include a Graphic User Interface (GUI) screen for providing two way communication with a user. To this end, GUI screen 38 can preferably include a color touch screen monitor for providing a menu of actions that a user can select for instructing the system to perform. Of course, one of skill in the art will recognize that any number of conventional input output devices can also be utilized.

As described herein, operating information can include any information pertaining to the operation of the system 100. For example, operating information can include directions for instructing the processor to perform automatic responses such as immediately closing the valve 21 upon the occurrence of a leak situation, or can include a report specifying the current water pressure of the building plumbing line 6, for example.

In operation, the system 100 can act to automatically control the amount and pressure of water supplied to a building based on the preferences of a particular user.

The process can be initiated by a user selecting an appropriate input on either the I/O unit 38 or an external device 15 having an operating system or specific programming configured to communicate with the processor 31 as described above. Upon detecting that a particular instruction has been requested, the processor 31 can instruct the water regulation unit 20 and/or the power supply unit 35 to perform a particular action in line with the instructions provided by the user.

For example, if the pressure sensor 23 reports a water pressure of 150 psi, and a user desires the pressure to be reduced to 100 psi, the processor 31 can instruct the actuator 22 to adjust the flow of incoming water until the sensor 23 reports 100 psi. At this time, the sensor can continue to report the water pressure in line 6 and the processor can send additional instructions to the water regulation unit based on these reports.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system for remotely controlling the supply and pressure of water to a building, said system comprising:
one or more sensors configured to detect the presence of water;
a water regulation unit configured to detect and control a flow and pressure of water entering the building; and
a control unit configured to communicate operating information with the water regulation unit, an external device and each of the one or more sensors, said control unit including a processor, a memory a transmitter and a receiver.

2. The system of claim 1, wherein each of the one or more leak sensors further includes a transmitter configured to communicate a leak situation to the control unit.

3. The system of claim 2, wherein said control unit is configured to instruct the water regulation unit to terminate the flow of water to the building in response to a leak situation.

4. The system of claim 1, wherein said water regulation unit comprises:
a communicator having a transmitter and receiver configured to send and receive operating information with the control unit;
a valve having a variable opening interposed between a water source and a main building water line;
a valve actuator configured to incrementally open and close the valve in response to operating information received by the communicator; and
a pressure sensor configured to determine a water pressure inside the main building water line and report the same to the control unit via the communicator.

5. The system of claim 4, wherein the control unit is further configured to instruct the valve actuator to incrementally open and close the valve in response to the determined water pressure, said.

6. The system of claim 1, wherein said control unit further includes a power supply unit configured to provide electrical power to a plurality of outlets.

7. The system of claim 6, wherein the processor is configured to specify an on or off position for each of said plurality of outlets.

8. The system of claim 1, wherein said control unit further includes an input/output device configured to exchange operating instructions with a user.

9. The system of claim 8, wherein said input/output unit comprises:
a graphic user interface touch screen console configured to provide two way communication with the user.

10. The system of claim 1, wherein the external device includes at least one of a cellular telephone, a personal data assistant, a computer and an infrared transmitter device.

11. The system of claim 10, wherein each of the controller and the external device are configured to communicate via at least one of a radio wave, wifi, bluetooth, infrared, and cellular communication methodologies.

12. The system of claim 1, wherein the controller further includes a cellular antenna configured to communicate with a cellular telephone via a commercial cellular system.
